(19) United States
(12) Patent Application Publication
(10) Pub. No.: US 2005/0150959 A1
(43) Pub. Date: Jul. 14, 2005

(54) Optical reader

(76) Inventors: John Izzo, Auburn, NY (US); Michael Robinson, Weedsport, NY (US); Timothy Fitch, Syracuse, NY (US); Donna Fletcher, Auburn, NY (US); Clayton Roberts, Tully, NY (US)

Correspondence Address: WALL MARJAMA & BILINSKI, 101 SOUTH SALINA STREET, SUITE 400, SYRACUSE, NY, 13202, US

(21) Appl. No.: 10/754,653

(22) Filed: Jan. 9, 2004

(51) Int. Cl. G06K 7/10

(52) U.S. Cl. 235/472.02

(57) ABSTRACT

An optical device for reading optical indicia, including: an optical imager including a first wireless transceiver and a base unit including a second wireless transceiver in communication with the first wireless transceiver. The base unit is configured to receive the optical imager and position the optical imager in an orientation so that the optical imager may be used in a presentation mode.

### BACKGROUND OF THE INVENTION

1. Field of the Invention

The invention relates to optical readers in general an particularly to optical readers reconfigurable from a hand held reader to a presentation reader and back.

2. Technical Background

In the retail environment bar codes have become the norm for identifying goods. Typically, each item is marked with a barcode that is associated with a description of the item and a price for the item is stored in a database. Checkout stations in retail settings typically employ either a stationary presentation type optical reader, such as, for example a flatbed scanner or a tethered hand held optical reader.

Flat bed scanner type optical readers typically require a cashier to manually move an item bearing an optical indicia into the field of view of the optical reader and orient the item such that the optical reader can decode the optical indicia. While flat bed scanner type optical readers may be adequate for scanning encoded optical indicia on small items that are easily moved through their field of view by a cashier, these types of optical readers have exhibited a number of deficiencies in dealing with large or heavy items.

Another approach has been to use a tethered hand held optical reader configured to operate in a presentation mode and mounted in a stand near the cash register. One drawback to this approach is that if the optical indicia on the item is out of reach of the tethered hand held optical reader the item must be repositioned into the optical indicia can be read by the tethered optical reader. This required repositioning largely negates the usefulness of operating the tethered optical reader in a presentation scan because it requires someone to move large and/or heavy objects thereby reducing the efficiency of the approach. Additionally, the movement of large and/or heavy objects is inherently risky. Further more, tethered hand held optical readers that operate in manual mode often require multiple trigger activations by the operator in order to capture a decodable image.

Another approach uses a tethered hand held optical reader that requires manual operation to read an optical indicia. Typically, the tethered reader is operated by a cashier and has limited operational range due to the tether. This limited range imparted by the tether makes this type of reader difficult to use when processing large items with manipulation of the item when the optical indicia is located away from the optical reader. In a manual mode, the optical reader requires an activation signal from a trigger to decode an optical indicia Often numerous trigger activations are required before the optical indicia is decoded. Unsuccessful attempts to decode an optical indicia often lead to operator or customer frustration and thus detract from customer satisfaction.

Another proposed approach uses an optical reader in wireless communication with a base unit in conjunction with a separate presentation type optical reader. In this approach the wireless optical reader is in held in a docking cradle or station until needed to read an optical indicia that is out of the view of the presentation optical reader. One drawback of this approach is the expense and inefficiencies of having to have multiple optical readers dedicated to each cashier station. The wireless optical readers used in this approach typically operate in a manual mode requiring an activation signal to be provided by a trigger in order to decode an optical indicia. Often numerous trigger activations are required before the optical indicia is decoded. Unsuccessful attempts to decode an optical indicia often lead to operator or customer frustration and thus detract from customer satisfaction.

### SUMMARY OF THE INVENTION

It would thus be desirable in some instances to have an optical reader capable of serving as a fixed presentation optical reader and as the need arises as serving as a portable hand held optical reader with range greater than that of conventional tethered hand held optical readers.

Therefore, and according to one illustrative embodiment of the present invention, there is provided an optical device for reading optical indicia, including: an optical imager including a first wireless transceiver and a base unit including a second wireless transceiver in communication with the first wireless transceiver. The base unit is configured to receive the optical imager and position the optical imager in an orientation so that the optical imager may be used in a presentation mode.

According to another embodiment of the present invention, there is provided an optical device for reading optical indicia. The optical device includes an optical reader configured for hand held operation. The optical reader is switchable between a manual mode and a presentation mode. The optical reader includes a housing configured for grasping by at least one hand, the housing defining an interior volume. The optical reader further includes an illumination member disposed within the interior volume and an image capture member disposed within the interior volume. The optical reader further includes a control circuit in communication with the illumination member and the image capture member and a a trigger member configured for activation by an operator, the trigger member in communication with the control circuit, the control circuit configured to instruct the image capture member to capture an image in response to the activation of the trigger member by the operator. The optical reader further includes a rechargeable power supply disposed within the housing, the rechargeable power supply coupled to the control circuit whereby electrical power is provided to the control circuit. The rechargeable power supply is coupled to the illumination member whereby electrical power is provided to the illumination member, and the rechargeable power supply is further coupled to the image capture member whereby electrical power is provided to the image capture member. The rechargeable power supply includes a first electrical contact member disposed proximate to the periphery of the housing. The optical device further includes a base unit configured to receive the optical reader and maintain the optical reader, when received, in an orientation that facilitates use of the optical reader as a presentation reader. The base unit includes a second electrical contact member configured to engaged the first electrical contact member, the second electrical contact member disposed such that when the optical reader is received by the base unit electrical conductivity is established between the first electrical contact member and said second electrical contact member whereby electrical power is supplied to the rechargeable power supply whereby the rechargeable electrical power supply may be recharged.

According to yet another embodiment of the present invention there is provided an optical device for reading optical indicia. The optical device includes a hand held optical reader. The hand held optical reader includes a housing. The hand held optical reader further includes an image sensor disposed within the housing and a light source disposed proximate to the image sensor, the light source configured to emit light. The hand held optical reader further includes an illuminating optical system disposed to receive light emitted from and direct abeam of light into the field of view of the image sensor thereby allowing an operator to illuminate a target indicia. The hand held optical reader further includes an operational control circuit coupled to the image sensor and the light source, the operational control circuit is configured to control the operation of the image sensor and the light source. The hand held optical reader further includes battery coupled to the operational circuit, whereby electrical power is supplied to the image sensor and the light source. The hand held optical reader further includes an electrical connector coupled to the battery, the electrical connector disposed proximate to an exterior surface of the housing whereby the electrical connector may be engaged with an external power supply. The hand held optical reader further includes a first wireless communication transceiver coupled to the image sensor, the wireless communication transmitted configured to transmit a signal containing information about the optical indicia. The optical device also includes a base unit configured to receive the hand held optical reader. The base unit further configured to position the hand held optical reader for use as a presentation reader. The base unit includes a power supply configured to provide electrical power to the battery when the hand held optical reader is received by the base unit, a second wireless communication transceiver configured for communication with the first wireless communication transceiver, and a communications interface whereby the base unit may be coupled to a host and engage in electronic communication with the host.

According to yet another embodiment of the present invention there is provided a transaction system. The transaction system includes a host, the host having a first communications port. The transaction system further includes a base unit in communication with the host. The base unit includes a battery charger, a first wireless transceiver, a second communications port configured for communication with the first communication port, the second communications port in communication with the wireless transceiver. The transaction system further includes a hand held unit removably engageable with the base unit. The hand held unit includes a housing. The hand held unit includes a battery disposed within the housing, and an image capture circuit coupled to the battery, the image capture circuit disposed within the housing. The image capture circuit includes an image sensor configured to convert a image into a first electrical signal and a decode circuit coupled to the image sensor. The decode circuit is configured to receive the first electrical signal and decode the first electrical signal. The decode circuit outputting a second electrical signal representative of information contained in the optical indicia. The hand held unit further includes a wireless transceiver coupled to the decode circuit, the wireless transceiver is disposed to receive the second electrical signal and broadcast the second electrical signal.

According to yet another embodiment of the present invention there is provided a method of using an optical reader. The method of using the optical reader includes the steps of providing an optical reader device configured for hand held operation and providing a base unit configured to receive the optical reader device. The method of using an optical reader further includes the steps of coupling the optical reader device to the base unit such that the optical reader device is positioned for operation as a presentation scanner and establishing electrical connectivity between a rechargeable power source disposed within the optical reader device and a power supply disposed within the base unit.

It is to be understood that both the foregoing general description and the following detailed description are merely illustrative examples of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention, and together with the description serve to explain the principles and operations of the invention.

### BRIEF DESCRIPTION OF THE DRAWINGS

FIG. 1 is a perspective view of an optical reader embodiment according to the present invention;

FIG. 2 is a perspective view showing the right side and rear of the optical reader of FIG. 1

FIG. 3 is a right side elevation view of the optical reader of FIG. 1;

FIG. 4 is a left side elevation view of the optical reader of FIG. 1;

FIG. 5 is a front elevation view of the optical reader of FIG. 1;

FIG. 6 is a rear elevation view of the optical reader of FIG. 1;

FIG. 7 is a top plan view of the optical reader of FIG. 1;

FIG. 8 is a bottom plan view of the optical reader of FIG. 1;

FIG. 9 is a perspective view of an embodiment of a hand held unit according to the present invention;

FIG. 10 is a perspective view of the hand held unit of FIG. 9 showing the front, bottom and left side of the hand held unit;

FIG. 11 is a top plan view of the hand held unit of FIG. 9;

FIG. 12 is a left side elevation view of the hand held unit of FIG. 9;

FIG. 13 is a right side elevation view of the hand held unit of FIG. 9;

FIG. 14 is a rear elevation view of the hand held unit of FIG. 9;

FIG. 15 is a front elevation view of the hand held unit of FIG. 9;

FIG. 16 is a bottom plan view of the hand held unit of FIG. 9;

FIG. 17 is a perspective view of an alternative embodiment an optical reader according to the present invention;

FIG. 18 is a front elevation view of the optical reader of FIG. 17;

FIG. 19 is a left side elevation view of the optical reader of FIG. 17;

FIG. 20 is a right side elevation view of the optical reader of FIG. 17;

FIG. 21 is a rear elevation view of the optical reader of FIG. 17;

FIG. 22 is a top plan view of the optical reader of FIG. 17;

FIG. 23 is a bottom plan view of the optical reader of FIG. 17;

FIG. 24 is a perspective view of the optical reader of FIG. 1 in which the cover is removed to show the image capture assembly,

FIG. 25 is an exploded cut away view of the hand held unit of the optical reader of FIG. 1;

FIG. 26 is a block diagrammatic representation of the components of disposed within the hand held unit of the optical reader of FIG. 1;

FIG. 27 is a block diagrammatic representation of the components of disposed within the base unit of the optical reader of FIG. 1;

FIG. 28 is a perspective view of the optical reader of FIG. 1 connected to a host; and

FIG. 29 is a perspective view of the optical reader of FIG. 1 reading an optical indicia.

### DETAILED DESCRIPTION OF THE PREFERRED EMBODIMENTS

Reference will now be made in detail to the present preferred embodiments of the invention, examples of which are illustrated in the accompanying drawings. Whenever possible, the same reference numerals will be used throughout the drawings to refer to the same or like parts for clarity.

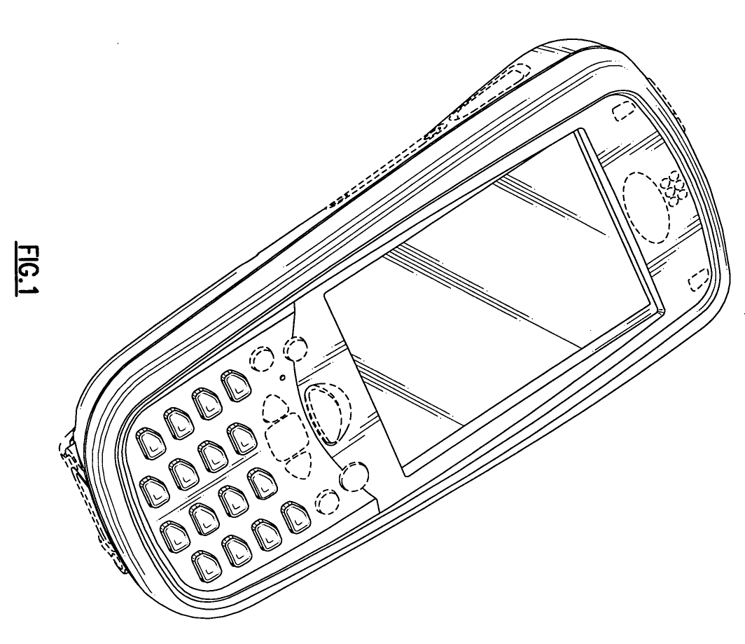

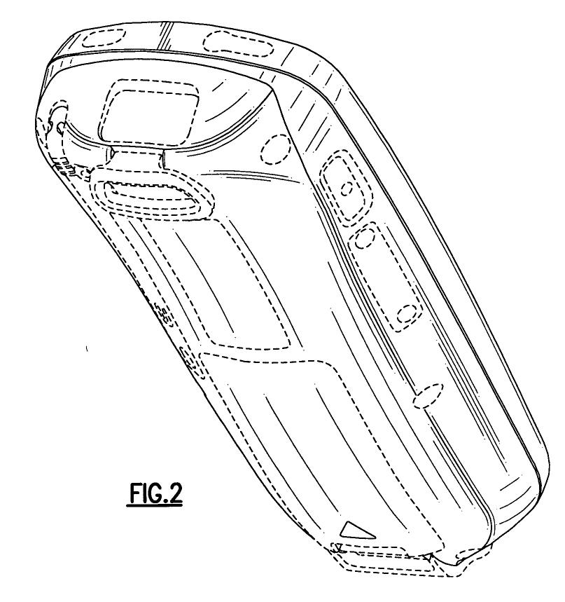

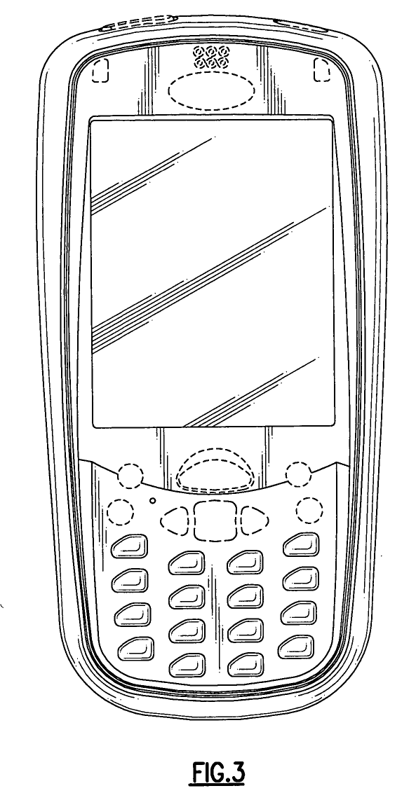

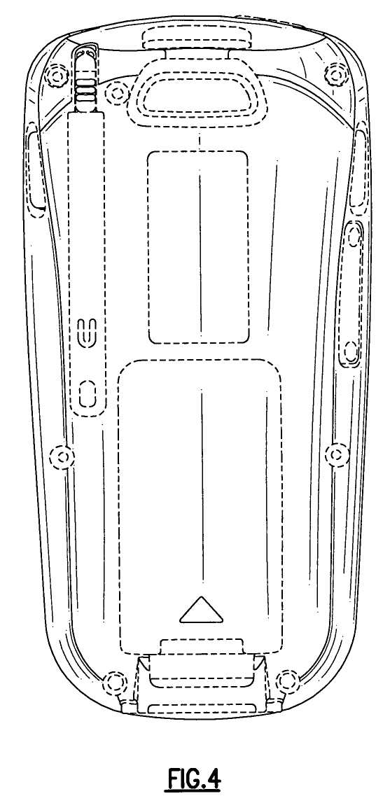

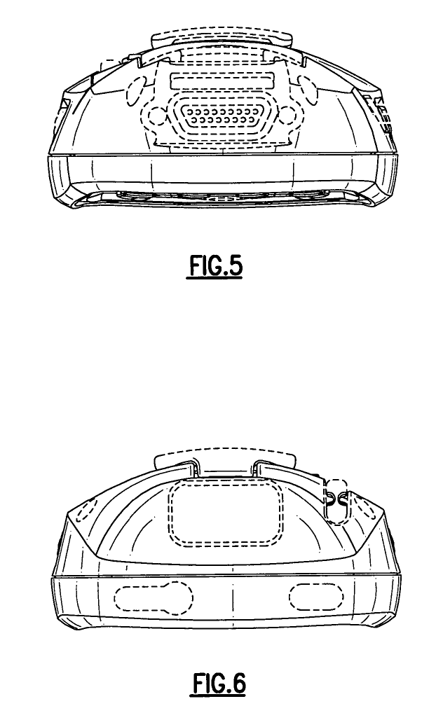

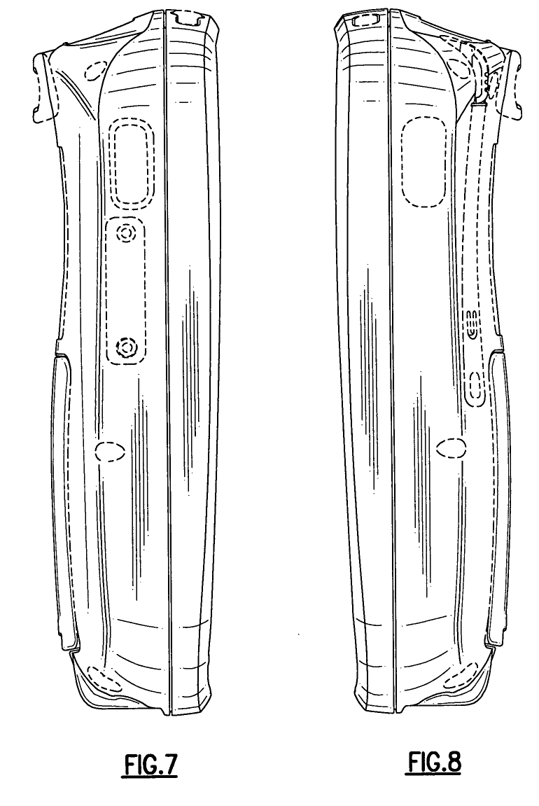

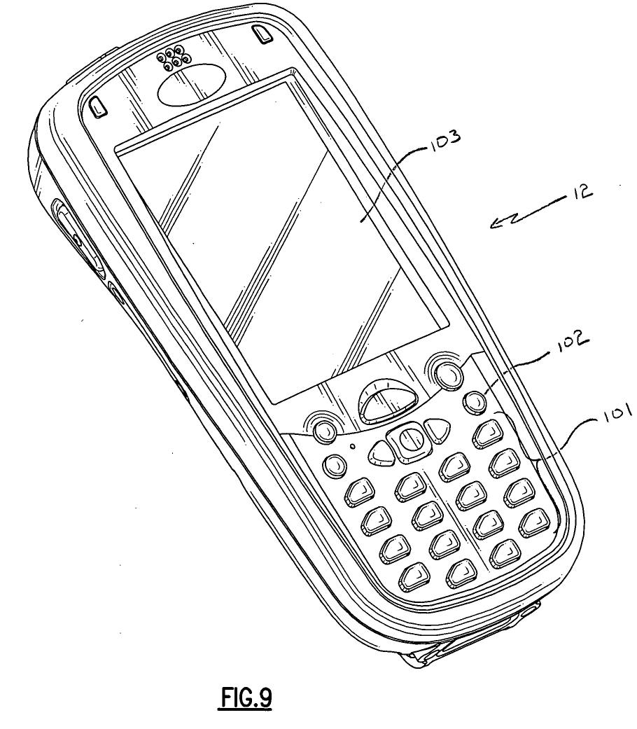

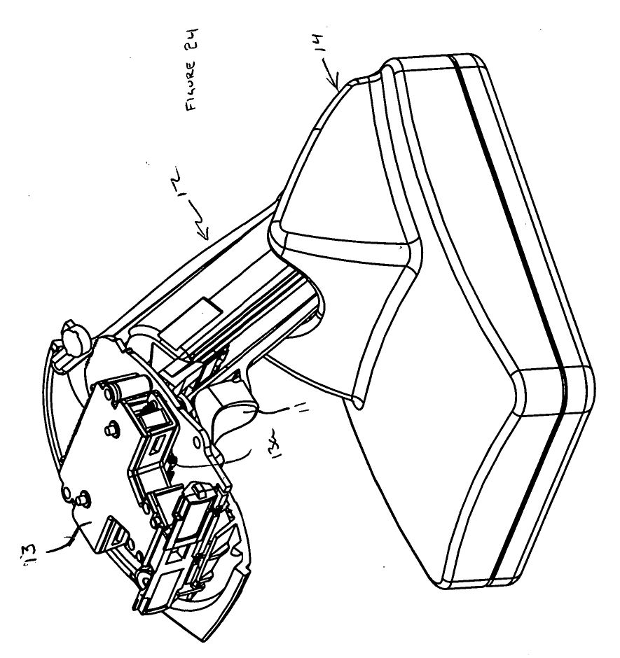

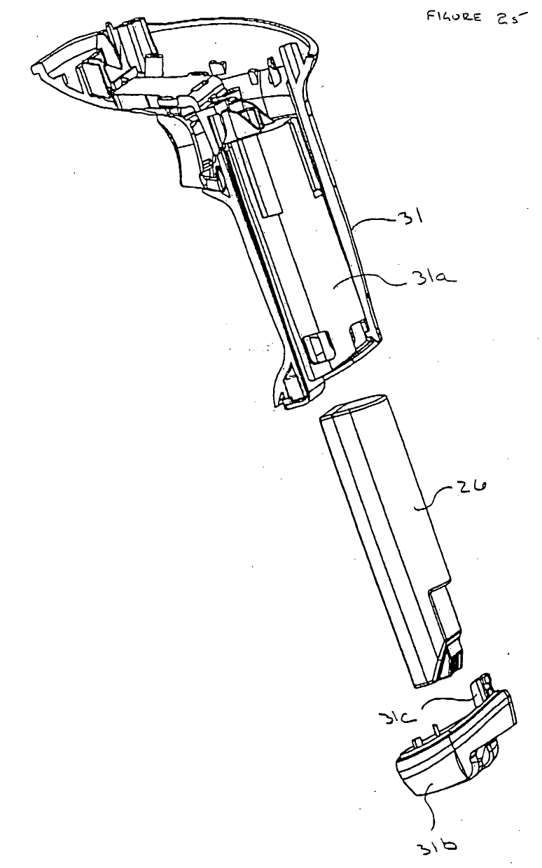

According to one embodiment, as shown in FIGS. 1-8, the present invention for an optical device 10 includes hand held unit 12 and a base unit 14. The hand held unit 12 is a battery operated optical reader including a handle portion. Turning to FIG. 26, there is shown in block diagram form the internal components of the hand held unit 12. It will be appreciated by those of ordinary skill in the art that although the hand held scanner is described as separate functional components, the functions of any of the separate components may be combined. The hand held unit 12 includes a scan engine 13 for decoding optical indicia, such as, for example bar codes or two dimensional optical codes. Examples of one and two dimensional optical symbologies include PDF417, MaxiCode, QR Code and Data Matrix. The disposition of the scan engine 13 within the hand held unit 12 may be more clearly understood with reference to FIG. 24. FIG. 24 shows the hand held unit 12 docked with the base 14 to form the optical device 10. The cover of the hand held unit 12 has been removed in FIG. 24 to show the scan engine 13. The scan engine is an optical reader that may be a laser scanning engine or an image capture device. An image capture device typically includes a semiconductor chip based image sensor utilizing an array of photosensors. In the embodiment shown in FIG. 24, the scan engine 13 is depicted as an image capture device. Examples of image capture devices are found in U.S. patent application Ser. No. 10/252,484 entitled “Long Range Optical Reader” filed Sep. 23, 2002 which is hereby incorporated herein by reference in its entirety; U.S. patent application Ser. No. 10/092,789, entitled “Optical Reader for Imaging Module” filed Mar. 7, 2002 which is hereby incorporated herein by reference in its entirety; U.S. patent application Ser. No. 10/093,136 entitled “Optical Reader Comprising Multiple Color Illumination” filed on Mar. 7, 2002 which is hereby incorporated herein by reference in its entirety; U.S. patent application Ser. No. 10/093,167, entitled “Optical Reader Comprising Finely Adjustable Lens Assembly” filed Mar. 7, 2002 which is hereby incorporated herein by reference in its entirety, and U.S. patent application Ser. No. 10/093,140 entitled “Optical Reader Aiming Assembly Comprising Aperture” filed on Mar. 7, 2002 which is hereby incorporated herein by reference in its entirety. Returning to FIG. 26, it can be seen that the hand held unit 12 further includes central processing circuitry 18 that includes image processing circuitry and control circuitry. The image processing circuitry 18 and the control circuitry 16 may be incorporated into one or more printed circuit boards 20. As shown in FIG. 26, the control circuitry is a separate electrical element that includes circuitry for power management. The hand held unit 12 further includes a wireless transceiver 22, such as, for example a Bluetooth® wireless device. The wireless transceiver 22 is configured to engage in two-way communication with at least one other wireless transceiver. The wireless transceiver may be located in the base unit 14 or may be connected to a host. Returning to FIG. 24, a printed circuit board 13a is coupled to the scan engine 13. The printed circuit board 13a includes the wireless transceiver 22.

As shown in FIG. 1, the base unit 14 is configured to receive the hand held unit 12 and hold the hand held unit 12 in a position that enables the hand held unit 12 to be used as a presentation optical reader.

Returning to FIG. 26, the hand held unit is powered by a rechargeable battery 26, such as, for example a NiCad or Lithium ion battery. The battery 26 is electrically connected to the scan engine 13, the wireless transceiver 22 and the central processing circuitry 18. Turning to FIG. 25 there is shown a cut away exploded view of the handle portion 31 of the hand held unit 12. The handle portion 31 is made from a high impact plastic and includes a battery housing 31a. The battery housing 31a is an elongate tubular member that defines a volume for receiving the battery 26. When installed in the battery housing 31a, the terminals (not shown) of the battery 26 engage electrical contacts inside the battery housing 31a, thereby providing electrical power to the hand held unit 12. The battery 26 is retained in the battery housing 31a by an end cap 31b. The end cap 31b includes resilient fingers that engage complementary structures in the handle 31 or battery housing 31a to secure the end cap 31b in place. In an alternative embodiment separate mechanical fasteners, such as, for example screws may be used to couple the end cap 31b to the handle 31. Returning to FIG. 26, the central processing circuitry 18 includes image processing circuitry for evaluating a captured image to see if it contains decodable indicia and for deciding indicia in the captured image. If the image processing circuitry is able to decode an optical indicia in the captured image, the image processing circuitry sends an electrical signal containing the decoded information to the wireless transceiver 22. The wireless transceiver 22 then transmits the decoded information to a wireless transceiver 24 in the base unit 14.

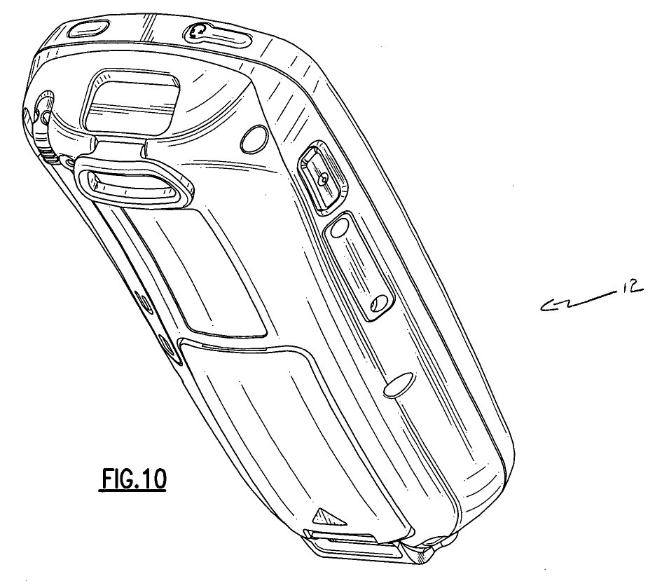

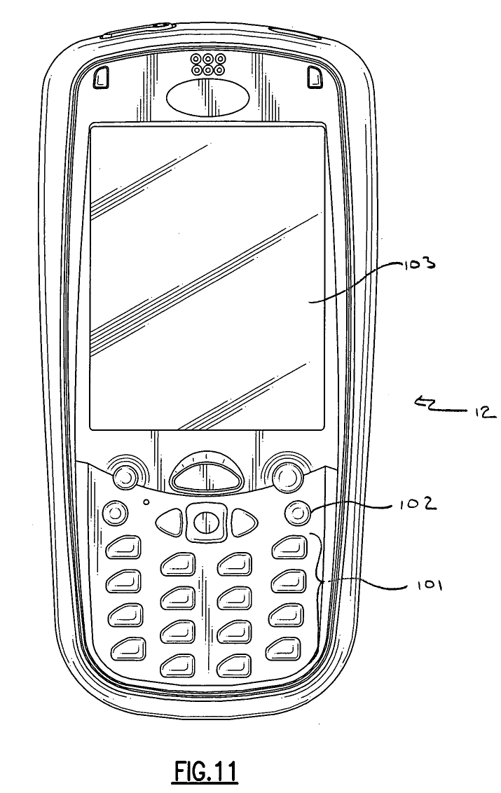

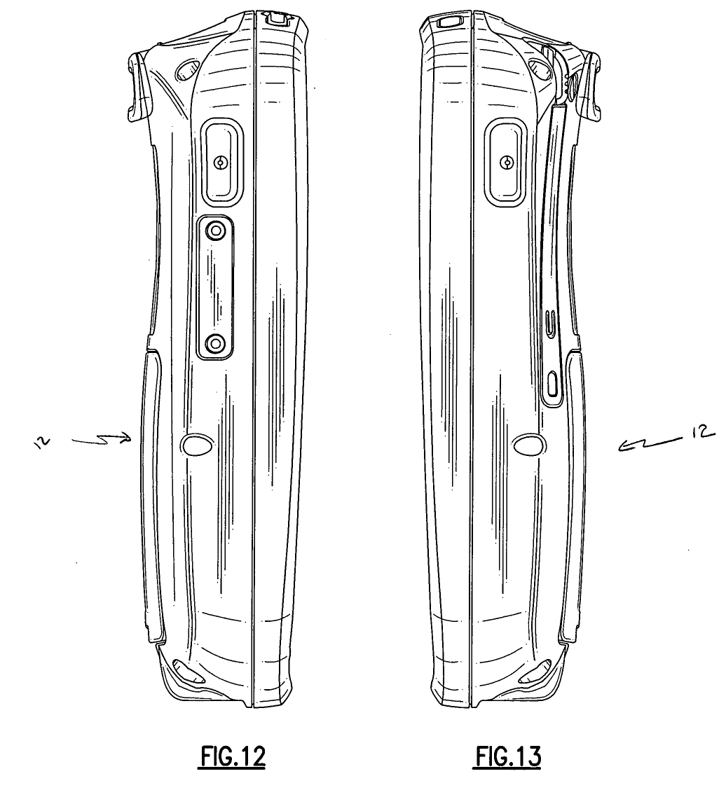

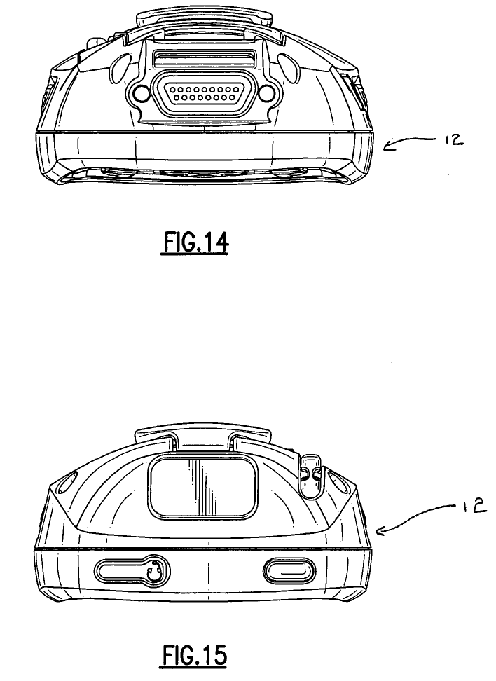

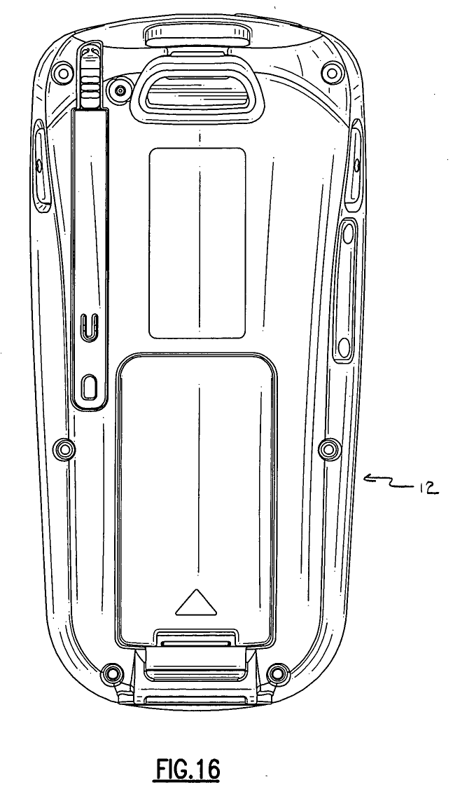

The hand held unit 12 may further include a user interface/accessory bus 17. The user interface may include light emitting diodes (LEDs), a beeper, a keypad, a display, a touch screen or any combination thereof. An example of a hand held unit 12 having a user interface is shown in FIGS. 9-16.

The hand held unit 12 further includes electronic memory both for storing operating instructions and for storing captured images and for use in the processing of the captured images. The memory may, for example, include random access memory or flash memory. As will be appreciated by those of ordinary skill in the electrical arts, the forgoing examples of memory types are illustrative of the types of memory that may be used in the present invention and are in no way limiting to the scope of the invention and that other suitable memory types may be used depending upon the applicable design criteria without the need for undue experimentation.

The hand held unit is equipped with an interface 27 for connecting the hand held unit 12 to the base unit 14. The interface 27 allows the hand held unit 12 and the base unit 14 to communicate with one another when the hand held unit 12 is engaged with the base 14. This interface allows the hand held unit 12 to receive power from the base unit 14 and to communicate with the base unit 14 without using a wireless system. When the hand held unit 12 is engaged with the base 14, the hand held unit 12 can communicate with the base unit 14 and receive communications from the host 25, such as for example software upgrades. This docking capability offers the advantage that the battery 26 of the hand held unit 12 may undergo constant recharging, or may be equipped with a timing circuit to enable recharging over night when power rates are typically lower. Further more, when docked overnight, the hand held unit 12 can receive download of new software in a secure mode without relying upon wireless encryption and the new software is installed when the hand held unit 12 is not being used. The interface may be, for example a RS-232 interface, a RS-422 interface or a magnetic induction interface.

In one embodiment, the interface is a four pin connector. Two or the four pins are dedicated to providing electrical power and while the third pin is a receive pin and the fourth pin is a transmit pin for two-way communication with the base unit 14. The base unit 14 includes a mating four pin connector.

The hand held unit 12 may also include a manual trigger 11. The trigger is positioned for operation of the fingers of the operators hand that is used to grasp the hand held unit. In the embodiment of the hand held unit 12 shown in FIG. 1, the hand held unit has a form factor that includes a handle 12a extending from the head 12b of the hand held unit 12. The trigger 11 is used signal the hand held unit 12 to capture an image when the hand held unit 12 is in manual mode. As shown in FIG. 13, the hand held unit may also have a form factor in which the trigger or triggers are mounted on the side or sides of the hand held unit 12.

While in the base unit, the hand held unit is configured to operate in “presentation mode”. As used herein, presentation mode, refers to the operational state of the hand held unit in which the hand held unit 12 is continuously attempting to capture and decode images or an automatic trigger mode in which the hand held unit 12 only captures an image and attempts to decode the image when an object is placed within the field of view of the image sensor of the hand held unit 12. A hand held unit 12 configured for operation in an automatic trigger mode form of presentation mode may include sensors, such as, for example motion sensors, infrared sensors or acoustical sensors to determine when an object has been placed in field of view of the image sensor. Alternatively, the image sensor itself may be used to detect the presence of an object.

As used herein “manual mode” refers to the operational state of the hand held unit that requires a manual trigger activation by the operator in order for the hand held unit to capture and attempt to decode an image. The hand held unit may be switched between manual mode and presentation mode by a number of techniques, including the decoding of an optical indicia containing instructions to switch from one mode to another, using a switch on the hand held unit 12 to toggle between operational modes, or sending an instruction from the host via the data port of the base/hand held unit interface. The hand held unit 12 may also be configured to change operational modes based on the operation of the trigger 11. For example, in one embodiment, when the trigger 11 is depressed or activated, the hand held unit 12 temporarily enters into manual mode for a predetermined period of time, such as, for example fifteen seconds, and then returns to presentation mode. Additionally, in some applications it may be desirable to have the hand held unit 12 always function in a presentation mode. In that instance the hand held unit 12 may be programmed to be constantly in presentation mode. In an alternative embodiment, the hand held unit 12 may be configured to automatically switch between a predetermined type of presentation mode and a manual mode depending on whether the hand held 12 is engaged with the base unit 14. For example, the hand held unit 12 may be equipped with a switch that is activated when the hand held unit 12 is docked with a base unit 14. The activation of the switch would toggle the hand held unit 12 into a presentation mode. Conversely, removal of the switch equipped hand held unit 12 from a base unit 14 would cause the switch to toggle the hand held unit 12 into manual mode operation. In an alternative embodiment, the hand held unit 12 may be equipped with sensor to determine if the hand held unit 12 is docked with a base unit 14. If the sensor indicates that the hand held unit 12 is engaged with a base unit 14, the hand held unit 12 operates in presentation mode. Similarly, if the sensor indicates that the hand held unit 12 is not currently engaged with a base unit 14, the hand held unit would operate in a manual mode. A more detailed description of operational image capture modes may be found in U.S. Pat. No. 6,585,159 entitled “Indicia Sensor System for Optical Reader” which is hereby incorporated herein by reference in its entirety.

As shown in FIGS. 1-8, the base unit 14 is configured to hold the hand held unit 12 in a position that is advantageous for reading optical indicia The scan engine 13 of the hand held unit 12 includes an imaging axis aᵢ. The imaging axis aᵢ is the optical axis about which the scan engine captures an image of an optical indicia. FIG. 29 shows the optical reader 10 of the present invention deployed to read barcodes in a commercial setting. The base unit 14 is configured to position the imaging axis aᵢ of the hand held unit 12 to allow the optical reader 10 to read barcodes on objects that slide along the counter. Thus, allowing the optical reader 10 to read bar codes that are parallel to the counter, substantially perpendicular to the counter or any where in between without removing the hand held unit 12 from the base unit 14. Preferably, the hand held unit 12 is oriented to avoid illuminating a user or customer with its onboard illumination sources.

Furthermore, the optical reader 10 is intended primarily for use on a counter near a checkout station and must be compact so as to use the least amount of counter space possible and light weight so that it may be easily repositioned so as to allow maximum usage of the surrounding counter space. The mass distribution of the hand held unit 12 is a matter of ergonomic design, depending in a large part on the size and location of the battery 26. The mass distribution of the base unit 14 is configured to provide a light weight, yet stable platform for receiving the hand held unit 12.

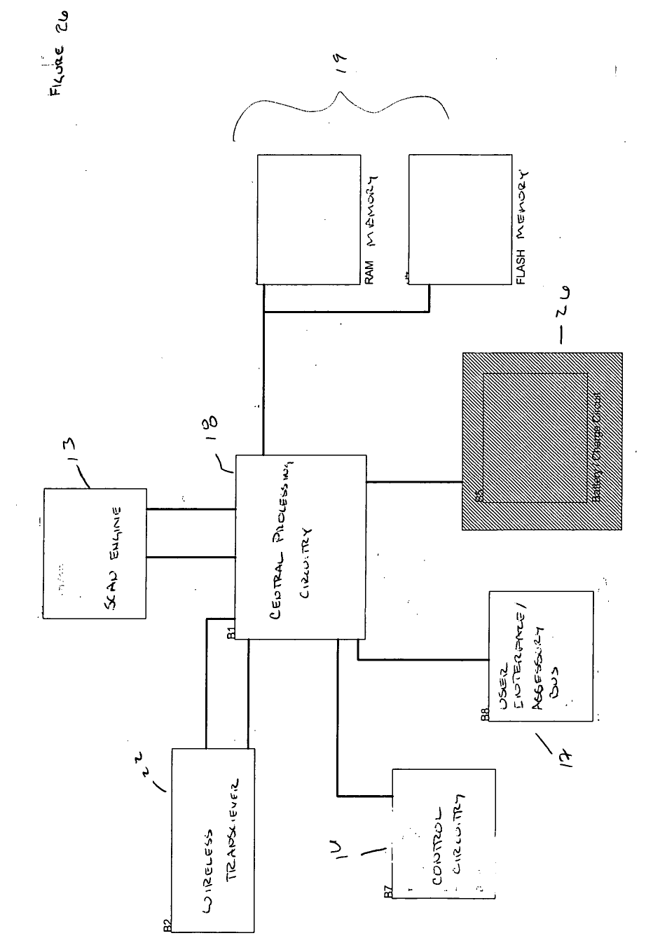

Turning to FIG. 27 there is shown in schematic of the electronic components of a wireless transceiver equipped base unit 14 in block diagram form. The base unit 14 includes a wireless transceiver 24, such as, for example a Bluetooth RF transceiver for communication with the hand held unit 12. In the embodiment shown, the wireless transceiver 24 includes a RF module 24a and an antenna 24b.

The base unit 14 further includes a control and interface assembly 24c and a battery charger 36. The control and interface assembly 24c includes at least one printed circuit board that includes input and output ports (I/O ports) for connecting to the host 24, a power source (not shown), which may include a power supply, the wireless transceiver 24 and the battery charger 36. The control and interface assembly 24c includes an electrical connector 30 configured for engagement with the interface 27. The control and interface assembly 24c further includes communications circuitry and power management circuitry. The power management circuitry controls the operation of the battery charger 36. The battery charger 36 may include a fast charger or a trickle charger or both.

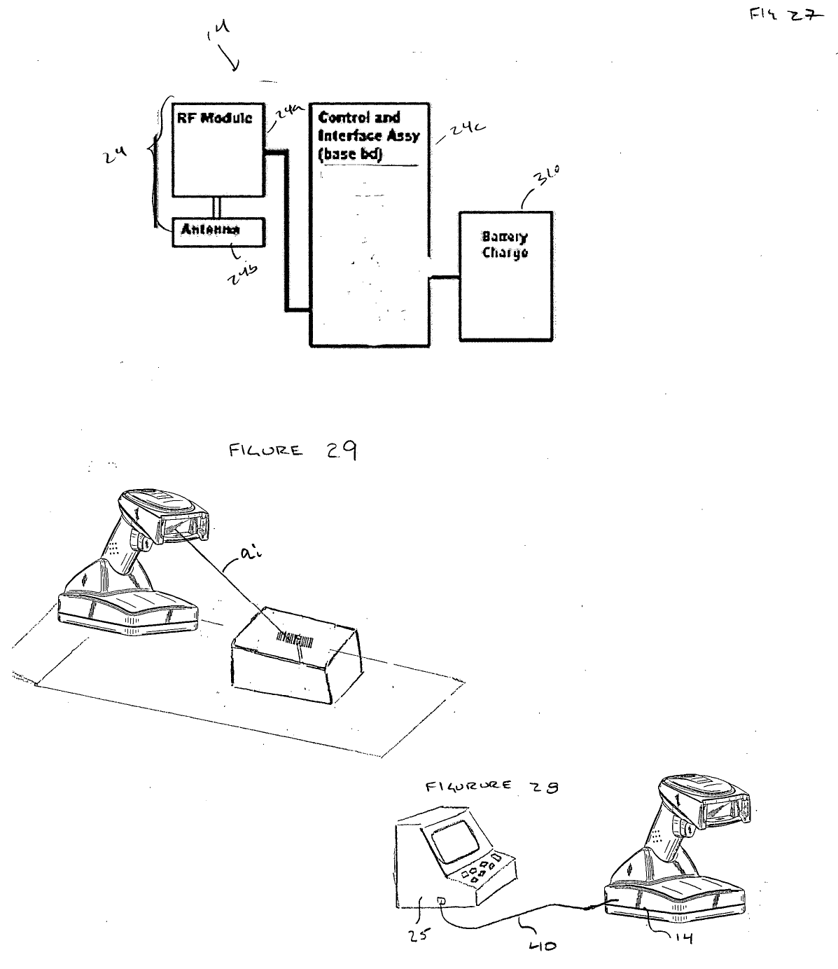

The communications circuitry of the control and interface assembly 24c is configured to control the operation of the wireless transceiver 24 and to communicate with the host 25. As shown in the block diagram of FIG. 28, the base unit 14 is connected to the host 25 via one of the I/O ports of the control and interface assembly 24c. The host 25 may be a computer, a plurality of computers, a personal digital assistant (PDA), a portable data terminal (PDT), a point of sale (POS) terminal, a transaction terminal or a cash register. In one embodiment, the base unit 14 is coupled to the host 25 by electrical cabling 40. The electrical cabling 40 is connected to a communications port of the host 25. The electrical cabling 40 includes data communication lines and may also include power lines. For example, if the host 25 is a computer, the communication port 38 of the base may be connected to the keyboard connection port of the computer. The keyboard connection port includes data communication terminals and power terminals. In this embodiment, the base 12 may advantageously use the electrical power available via the keyboard connection port to both power communications circuitry of the base unit 14 and to operate the battery charger 36 in a trickle charging mode. Returning to FIG. 27, the power management circuitry of the control and interface assembly 24c is configured to determine if the electrical power being supplied to the battery charger 36 is from the host 25 or another source, such as, for example an external power supply or wall receptacle. The host 25 is typically configured to operate a software program, such as for example an inventory control or transaction program.

One of the I/O ports of the control and interface assembly 24c may be configured as an electrical connector for coupling the base unit 14 to a power source (not shown) capable of supplying electrical power to the base unit such that the battery charger 36 may operate in a fast recharge mode.

In operation, the hand held unit 12 and the base unit 14 are associated with one another. It should be noted that more than one hand held unit 12 may be associated with a base 14 at any one time. In an embodiment of the present invention in which the Bluetooth wireless communication protocol is used each hand held unit 12 and each base unit 14 is identified with a unique identifier that is readily accessible by the operator, such as, for example a bar code or other optical indicia applied to an external surface. A hand held unit 12 is associated with a specific base unit 14 by entering the unique identifier into the hand held unit 12, such as, for example by scanning the optical indicia or bar code on the base unit 14. The optical indicia either contains instructions or is recognized by the hand held unit as a command to execute a set of instructions stored within the circuitry of the hand held unit 12. In response to reading the optical indicia, the hand held unit 12 configures itself to address all wireless transmissions sent from its wireless transceiver to the base unit 12. The hand held unit 12 then broadcasts a wireless transmission addressed to the base unit 14. The wireless signal includes information about the hand held unit 12 that allows the base unit 14 to communicate with the hand held unit. For example, when a Bluetooth wireless system is used, the information contained in the wireless signal will include the unique address of the hand held unit 12. The base unit 14 stores the wireless address of the hand held unit 12 and adds the wireless address of the hand held unit 12 to the list of wireless devices with which the base unit 14 may communicate. The reader and the scanner are then associated with one another. Additionally, the reader could be associated with a dongle device that incorporates wireless communication capability coupled directly to a host. For example, the dongle device may include a USB dongle utilizing the Bluetooth standard. Additionally, in some applications (other than a retail transaction application) it may be desirable to have multiple hand held readers associated with a single base unit. Such an application may include an industrial or inventory control setting.

The modular nature of the optical device 10 readily lends itself to specialization of either the hand held unit 12 or the base unit 14 from the embodiments described above. Fore example, in another embodiment according to the present invention, the base unit 14 is configured to hold the hand held unit 12 in a substantially vertical position. The base unit 14 includes a battery charger 36 for recharging the battery 26 of the hand held unit 12. The battery charger 36 may be a contact type charger or an inductive type charger. The battery charger 36 may be a fast charger, a trickle charger or a charger that is selectively switchable between fast and trickle charging modes.

In another embodiment according to the present invention, the base unit 14 is configured to hold the hand held unit 12 is a substantially vertical position. The base unit 14 contains a wireless transceiver 24 for communication with the hand held unit 12 and may not include a battery charger. A base unit 14 in this configuration is particularly suitable for association with multiple hand held units 12, where each of the batteries of the hand held units 12 would be recharged by a dedicated battery charger or a base unit 14 that includes a battery charger but with which the hand held unit 12 is not associated with for two way communication as the term association is used herein.

In another embodiment according to the present invention, the base unit 14 includes circuitry for decoding image signals transmitted from the hand held unit 12.

In another embodiment, the hand held unit 12 is in direct wireless communication with the host 25. The hand held unit 12 may directly communicate with a host 25 when the host 25 includes a wireless transceiver, such, as for example a Bluetooth wireless device in the form of a USB dongle.

In another embodiment, the hand held unit 12 may be associated with a more complex and fully featured portable device, such as, for example a portable computer or a portable data terminal configured for wireless communication. In this was the reach and capabilities of the portable data terminal may be more completely utilized.

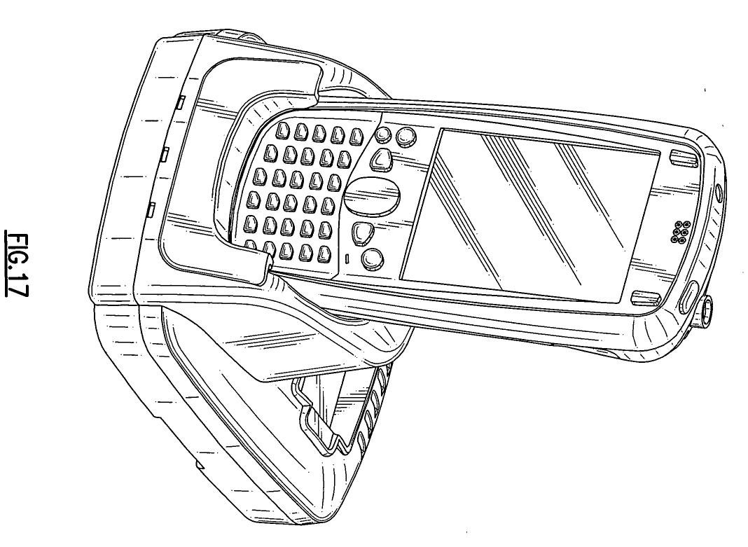

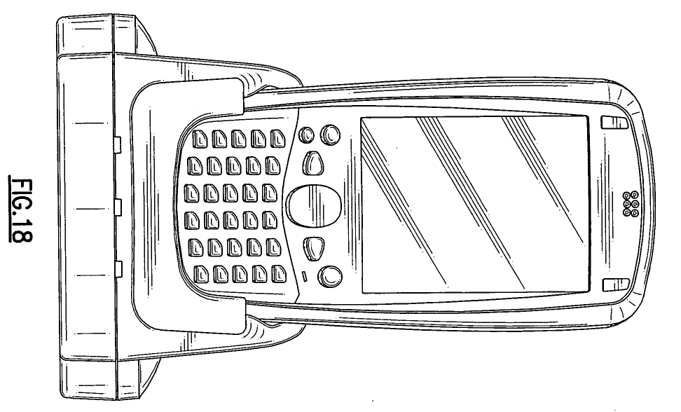

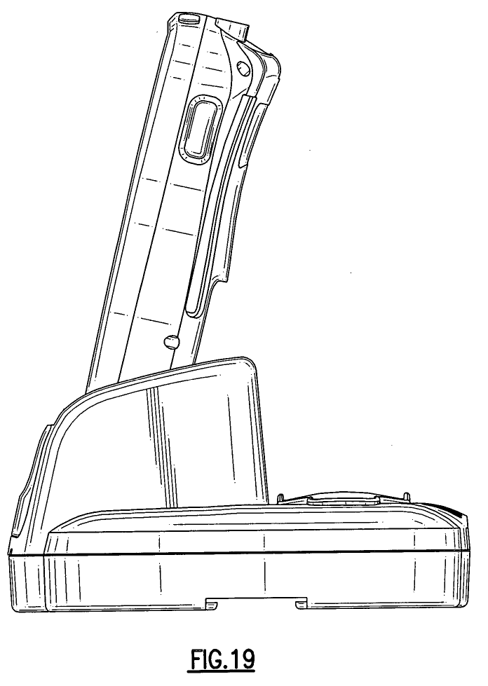

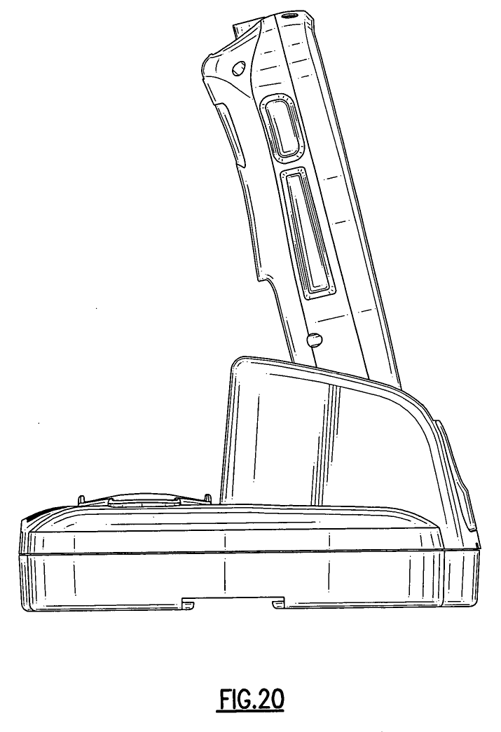

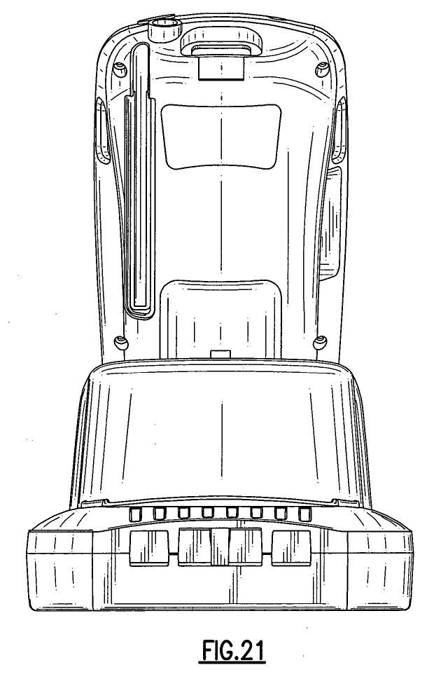

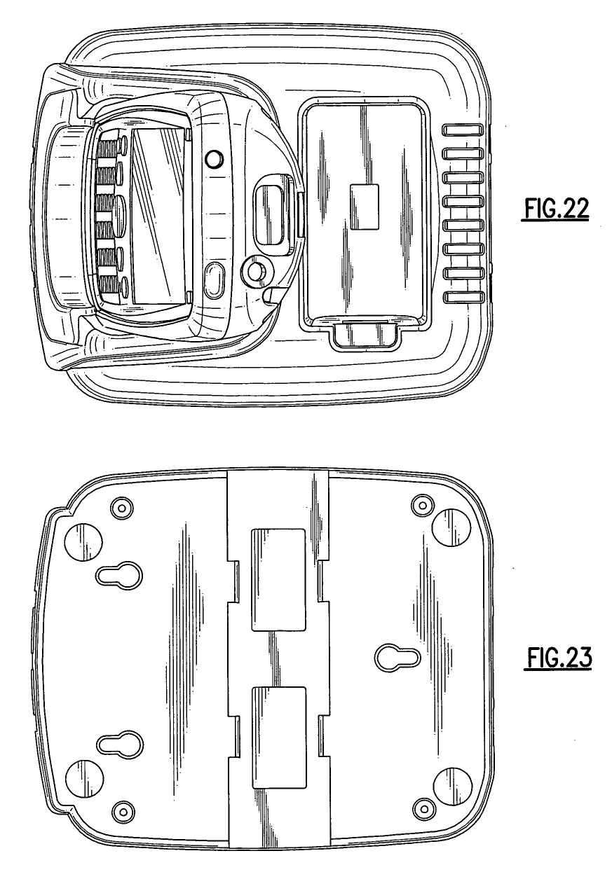

In another embodiment, as shown in FIGS. 17-23, the hand held unit 12 is a portable data terminal, such as, for example a Dolphin 7400 Mobile Computer, available from Hand Held Products, Inc. of Skaneateles Falls, N.Y. A more comprehensive description of the portable data terminals may be found in U.S. patent application Ser. No. 10/669,896 entitled “Memory Content Copying System for Devices” filed on Sep. 23, 2003 and U.S. patent application Ser. No. 10/669,894 entitled “Reprogramming System for Portable Devices” filed Sep. 23, 2003 on both of which are hereby incorporated herein by reference in their entireties. The portable data terminal may include one or more of the following user interfaces: a touch screen, a key pad, manual triggers and one or more function keys. The external features of the portable data terminal shown as the hand held unit 12 of FIGS. 17-23 are more clearly shown in FIGS. 9-16. As shown in FIG. 9-16 the hand held unit 12 includes a key pad 101, function keys 102 and a display screen 103. The display screen 103 may be configured to include a touch screen.

In another embodiment according to the present invention, the optical device 10 is configured for operation in a hostile environment. For example, if the optical device 10 is to be used in a high humidity environment, both the hand held unit 12 and the base unit 14 may be hermetically sealed units. In this embodiment, the battery charger 36 of the base unit 12 would charge the battery by magnetic induction. And the hand held unit 12 may communicate with the base unit using an optical communication system, such as, for example a free space infrared system, when the hand held unit 12 is docked to the base unit 14 in addition to communication via the wireless transceivers. Alternatively, the hand held unit 12 and the base unit 14 could be configured to communicate with one another using magnetic induction when the hand held unit 12 is docked to the base unit 14.

Additionally, the optical device 10 may be configured such that hand held unit 12 and the base unit 14 are electrically isolated from one another. Data transfer between the electrically isolated base unit 14 and the hand held unit 12 may be accomplished using, for example, an optical link or an inductive electromagnetic link. Similarly, power may be supplied to the hand held unit 12 by magnetic induction. Such a system may prove advantageous in an environment where the risk of an electrical spark must be minimized, such as, for example regions where combustible vapors are present.

In yet another embodiment according to the present invention, the base unit 14 includes electrical circuitry for decoding images captured by the hand held unit 12. Thus, the decode circuitry may be omitted from the hand held unit 12. Images of optical indicia captured by the hand held unit 12 are transmitted to the base unit 14 where an attempt is made to decode the optical indicia. If the optical indicia is successfully decoded the operator is signaled, for example by an auditory or visual cue, that the optical indicial was successfully decoded and that the optical device 10 is ready to read another optical indicia. If the optical indicia is not successfully decoded then the base unit 14 may signal the operator that the decode attempt was unsuccessful, such as, for example by a auditory or visual cue that is different from the cue indicating a successful decode.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

1. An optical device for reading optical indicia, comprising:
a optical imager including a first wireless transceiver; and
a base unit including a second wireless transceiver in communication with the first wireless transceiver, the base unit configured to receive the optical imager and position the optical imager in an orientation so that the optical imager may be used in a presentation mode.

2. An optical device for reading optical indicia, comprising:
an optical reader configured for hand held operation, the optical reader switchable between a manual mode and a presentation mode, the optical reader including:
a housing configured for grasping by at least one hand, the housing defining an interior volume;
an illumination member disposed within the interior volume;
an image capture member disposed within the interior volume;
a control circuit in communication with the illumination member and the image capture member;
a trigger member configured for activation by an operator, the trigger member in communication with the control circuit, the control circuit configured to instruct the image capture member to capture an image in response to the activation of the trigger member by the operator; and
a rechargeable power supply disposed within the housing, the rechargeable power supply coupled to the control circuit whereby electrical power is provided to the control circuit, the rechargeable power supply coupled to the illumination member whereby electrical power is provided to the illumination circuit, and the rechargeable power supply coupled to the image capture member whereby electrical power is provided to the image capture member, the rechargeable power supply including a first electrical contact member and disposed proximate to the periphery of the housing; and
a base unit configured to receive the optical reader and maintain the optical reader when received in an orientation that facilitates use of the optical reader as a presentation reader, the base unit including a second electrical contact member configured to engaged the first electrical contact member, the second electrical contact member disposed such that when the optical reader is received by the base unit electrical conductivity is established between the first electrical contact member and said second electrical contact member whereby electrical power is supplied to the rechargeable power supply whereby the rechargeable electrical power supply may be recharged.

3. The optical device of claim 2 wherein said housing further includes a handle extending therefrom.

4. The optical device of claim 2 wherein the illumination member includes at least one light emitting diode.

5. The optical device of claim 4 wherein the at least one light emitting diode emits light having a wavelength within the visible spectrum.

6. The optical device of claim 2 wherein the illumination member includes at least one white light emitting diode.

7. The optical device of claim 2 wherein the image capture member includes a color image capture device.

8. The optical device of claim 2 wherein an optical indicia is used to set the operational mode of the optical reader.

9. An optical device for reading optical indicia, comprising:
a hand held optical reader, the hand held optical reader including:
a housing;
an image sensor (optical reader) disposed within the housing;
a light source disposed proximate to the image sensor, the light source configured to emit light;
an illuminating optical system disposed to receive light emitted from and direct a beam of light into the field of view of the image sensor thereby allowing an operator to illuminate a target indicia;
an operational control circuit coupled to the image sensor and the light source, the operational control circuit is configured to control the operation of the image sensor and the light source;
battery coupled to the operational circuit, whereby electrical power is supplied to the image sensor and the light source;
an first electrical connector coupled to the battery, the electrical connector disposed proximate to an exterior surface; and
a first wireless communication transceiver coupled to the image sensor, the wireless communication transmitted configured to transmit a signal containing information about the optical indicia;
a base unit configured to receive the hand held optical reader, the base unit further configured to position the hand held optical reader for use as a presentation reader, the base unit including:
a power supply configured to provide electrical power to the battery when the hand held optical reader is received by the base unit;
a second wireless communication transceiver configured for communication with the first wireless communication transceiver;
an second electrical connector disposed to engage the first electrical connector when the hand held unit is received by the base unit;
a communications interface whereby the base unit may be coupled to a host and engage in electronic communication with the host.

10. The optical device of claim 9 wherein the image sensor includes a laser scanning engine.

11. The optical device of claim 9 wherein the image sensor includes an imaging device.

12. The hand held reader of claim 9 further including a handle region.

13. The hand held reader of claim 9 further including a manual activation member disposed within the handle region.

14. The hand held reader of claim 9 further including at least two spaced apart side surfaces, each of the two spaced apart side surfaces having disposed thereon at least on manual activation member.

15. A transaction system comprising:
a hand held unit removably engageable with the base unit, the hand held unit including:
a housing, the housing defining an interior volume;
an image sensor disposed within the interior volume;
a decode circuit disposed within the housing, the decode circuit in electrical communication with the image sensor whereby the decode circuit attempts to decode images captured by the image sensor;
a second wireless transceiver configured for communication with the first wireless transceiver, the second wireless transceiver in electronic communication with the decode circuit; and
a hand held unit for reading an optical indicia, the hand held unit removably engageable with the base unit, the hand held unit including:
a housing;
a battery disposed within the housing; and
an image capture circuit coupled to the battery, the image capture circuit disposed within the housing, the image capture circuit including:
an image sensor configured to convert a image into a first electrical signal;
a decode circuit coupled to the image sensor, the decode circuit configured to receive the electrical signal and decode the first electrical signal, the decode circuit outputting a second electrical signal representative of information contained in the optical indicia;
a wireless transceiver coupled to the decode circuit, the wireless transceiver disposed to receive the second electrical signal and broadcast the second electrical signal.

16. The transaction system of claim 15 wherein the host includes a central computer.

17. The transaction system of claim 15 wherein the host includes a plurality of networked computers.

18. The transaction system of claim 15 wherein the host includes a transaction terminal.

19. The transaction system of claim 15 wherein the host includes a point of sale terminal.

20. The transaction system of claim 15 wherein the host includes a cash register.

21. An optical device comprising:
a hand held unit, the hand held unit including an optical reader; and
a base unit configured to receive the hand held unit and maintain the hand held unit in an upright position whereby the hand held unit may capture images of optical indicia, the base unit configured for wireless communication with the hand held unit.

22. The optical reader of claim 21, wherein the hand held unit is removably engageable with the base unit.

23. The optical reader of claim 22, wherein the hand held unit includes a rechargeable battery.

24. The optical device of claim 22 wherein the optical reader includes an CCD device.

25. The optical device of claim 22 wherein the base includes circuitry for decoding optical indicia.

26. The optical device of claim 22 wherein the hand held unit includes circuitry for decoding optical indicia.

27. The optical device of claim 23 wherein the base includes a battery charger.

28. The optical device of claim 27 wherein the battery charger uses magnetic induction to supply power to the rechargeable battery.

29. The optical device of claim 22 wherein the hand held unit is hermetically sealed.

30. The optical device of claim 29 wherein the base unit is hermetically sealed.

31. The optical device of claim 22 wherein the base unit is hermetically sealed.

32. A method of using an optical reader comprising the steps of:
providing an optical reader device configured for hand held operation;
providing a base unit configured to receive the optical reader device;
coupling the optical reader device to the base unit such that the optical reader device is positioned for operation as a presentation scanner; and
establishing electrical connectivity between a rechargeable power source disposed within the optical reader device and a power supply disposed within the base unit.
